(19) United States
(12) Patent Application Publication
(10) Pub. No.: US 2011/0287323 A1
(43) Pub. Date: Nov. 24, 2011

(54) Electrode and Insulator Structure for Battery and Method of Manufacture

(76) Inventor: Jack Chen, Oak Brook, IL (US)

(21) Appl. No.: 12/783,738

(22) Filed: May 20, 2010

(51) Int. Cl. H01M 2/18

(52) U.S. Cl. 429/246

(57) ABSTRACT

A battery core is made from a strip of insulating material folded longitudinally to form parallel panels. In one embodiment there are four panels and in another five panels. A positive electrode strip has an exposed foil center strip and positive electrode material along both edges. The positive electrode is folded around one fold of the insulator with the strip of foil exposed at the fold. A negative electrode strip has an exposed center strip and negative electrode material along both edges. The negative electrode is folded around a different fold of the insulator with the strip of foil exposed.

The present invention relates to the electrodes of batteries and in particular to a bundled combination of an insulator and positive, negative electrodes for forming a battery.

### BACKGROUND OF THE INVENTION

An electric automobile requires a rechargeable storage cell that can store a sufficient amount of electric energy to power the vehicle for reasonable usage. To maximize the power that can be stored within a fixed volume of a cell, the surface area of the various electrodes is maximized while the remaining elements, namely the insulating material between adjacent opposing electrodes and the electrolyte, are minimized. To maximize the surface area, an electrode is formed by depositing a layer of a porous material suitable for use as a battery electrode, such as an oxide, on the surface of a metallic foil. The battery is then formed by stacking alternating layers of positive and negative electrodes, with a thin insulator saturated with the electrolyte between each pair of electrodes.

U.S. Pat. No. 6,740,446 B2 issued May 25, 2004 to Corrigan discloses an insulator that is folded back and forth upon itself in a zigzag shape, with electrodes positioned between the folds of the insulator. In similar fashion, U.S. Pat. No. 7,195,840 B2 issued Mar. 27, 2007 to Kaun discloses an S-shaped insulator with positive and negative electrodes positioned in opposite loops of the S. Both the patents to Kaun and to Corrigan include detailed descriptions of the chemical makeup of the electrodes and electrolytes for various types of batteries and both these references are incorporated herein by reference to provide the reader with the background material provided therein.

Prior efforts to manufacture a high energy battery have resulted in factors that may lead to battery failure. Where the battery is configured by rolling a long strip of folded material, such as the cell structure disclosed in U.S. Pat. No. 7,195,840 B2 to Kaun, the coiled material may result in a short occurring between adjacent loops of the coil. Most likely, the short would occur where the distal end of one S-shaped insulator abuts against the end of the next layer of S-shaped insulator. The coil of Kaun will also be expensive to manufacture because of the precision required to position the ends of the S-shaped insulators to abut each other without overlapping. The elongate electrodes disclosed in U.S. Pat. No. 6,740,446 B2 to Corrigan require that electric energy flow along the length of coil material thereby generating a great deal of heat within the coils. Unless adequate cooling is provided to the Corrigan battery, the heat buildup can result in battery failure.

As can be seen from the forgoing, there is a need for a battery that has large surface area electrodes which can be easily and inexpensively manufactured, that provides adequate insulation against shortage, and does not require an elongate current path.

The insulators and positive and negative electrodes of a high energy battery are thin members, having thicknesses in the thousandths of an inch. The technology currently exists to inexpensively manufacture such elongate strips, but the difficulty lies in finding an inexpensive method to combine the various strips to form a reliable high energy battery. Existing methods to manufacture an inexpensive high energy battery have not been successful because the end product has been subject to failure either by internal shorts or overheating. Improving the reliability of the battery, on the other hand, has greatly increased costs or has reduced the energy storage capacity of the battery. There is therefore a need for an improved method of inexpensively combing the various films of electrodes and insulators to provide a high energy capability without sacrificing reliability.

### SUMMARY OF THE INVENTION

Briefly, the present invention is embodied in a battery having a positive electrode, a negative electrode, an insulating material between the electrodes, and an electrolyte. The insulating material is configured as an elongate strip having a length and first and second parallel longitudinal edges. In one embodiment, the strip of insulating material has at least three elongate folds therein, the folds extending parallel to the longitudinal edges thereby creating at least four parallel panels, with each panel separated from an adjacent panel by one of the folds.

A positive electrode includes a foil strip having a length that is a little shorter than the length of the strip of insulating material, and having first and second parallel longitudinal edges. The foil is folded longitudinally midway between the edges to form two foil panels joined at the fold. A region of positive electrode material is positioned on opposing surfaces of each of the two foil panels leaving a portion of the foil along both surfaces of the fold free of the positive electrode material so as to not inhibit the fold, and to leave a thin strip of foil exposed at the fold.

In similar fashion, a negative electrode includes an elongate strip of foil having a length a little shorter than the length of the strip of insulating material and having first and second parallel longitudinal edges. The foil for the negative electrode has one longitudinal fold therein midway between the first and second longitudinal edges wherein the foil is divided into two foil panels joined at the fold. A region of negative electrode material is applied to the opposing surfaces of the two foil panels, with a strip of the foil extending along both surfaces of the fold being free of negative electrode material so as not to inhibit the fold, and to leave a strip of the negative electrode foil exposed along the fold.

The first and second panels of the positive electrode are positioned around the exterior of the fold joining two of the panels of the strip of insulating material and the first and second panels of the negative electrode are positioned around the exterior of the fold joining another two panels of the strip of insulating material, with the exposed foil at the fold of the positive electrode extending outward of the insulating material in a first direction and the exposed foil at the fold of the negative electrode extending outward of the insulating material in a second direction that is opposite the first direction.

In accordance with the invention, the strip of insulating material with the positive electrode strip and negative electrode strip woven therein as described form an elongate bundle. The outer surfaces of the bundle are made of insulating material such that several bundles can be arranged in parallel to form a rectangular battery, or one bundle can be coiled to form a cylindrically shaped battery, or folded back and forth upon itself to form a rectangularly shaped battery.

### BRIEF DESCRIPTION OF THE DRAWINGS

A better understanding of the present invention will be had after a reading of the following description taken in conjunction with the drawings wherein:

FIG. 1 is a cross-sectional view of a battery having a battery core in accordance with the present invention assembled between suitable collector plates;

FIG. 2 is a top elevational view of a strip of insulating material foldable into elongate parallel panels to receive positive and negative electrodes and form the core of the battery shown in FIG. 1;

FIG. 3 is a cross-sectional view of a strip of an electrode having the electrode material removed along the center line of a foil prior to assembly to the insulating material as shown in FIG. 4;

FIG. 4 is an exploded, isometric view of an insulator folded as shown in FIG. 2, around which positive and negative electrodes are fitted to form the battery core shown in FIG. 1;

FIG. 5 is another isometric view of the folded insulator shown in FIG. 4 with the positive and negative electrodes inserted into the folds;

FIG. 6 is a partially cross-sectional and partially isometric view of the positive and negative electrodes assembled around an insulator as shown in FIGS. 4 and 5, with the parts compressed together into a bundle suitable for assembly into a battery;

FIG. 7 is an isometric view of a plurality of bundled strips shown in FIG. 6 assembled in side-by-side arrangement suitable to form the core of the battery shown in FIG. 1;

FIG. 8 is an isometric view of an elongate bundled strip as shown in FIGS. 4, 5, and 6 configured into a coiled battery core for insertion between positive and negative collector plates to form a battery;

FIG. 9 is a top elevational view of an elongate bundled strip of electrodes and insulator assembled as shown in FIGS. 4, 5, and 6 and oriented in a serpentine configuration to thereby form an alternative configuration for a battery core in accordance with the invention;

FIG. 10 is an exploded view showing positive and negative electrodes formed in accordance with FIG. 3 positioned for assembly around an alternate configuration for an insulator having three longitudinal folds;

FIG. 11 is a fragmentary isometric view of the parts shown in FIG. 10 in assembled relationship prior to compressing into an elongate bundle, and

FIG. 12 is an isometric view of a bundle of parts assembled in accordance with FIGS. 10 and 11 suitable for forming the core of a battery;

FIG. 13 is a side elevational view of a bundle for forming a battery in accordance with the simplest form of the invention.

### DETAILED DESCRIPTION OF PREFERRED EMBODIMENT

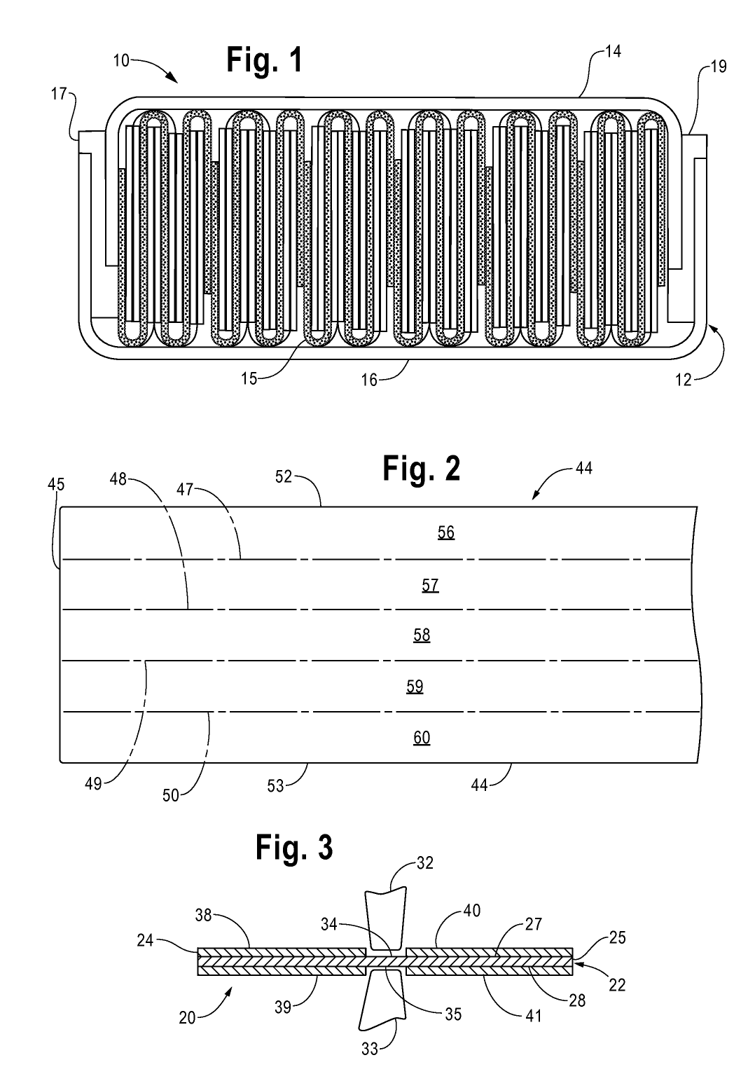

Referring to FIG. 1, a battery 10 in accordance with the invention includes a housing 12. The housing 12 includes a positive collector plate 14 that extends across an upper end of a battery core 15, and a negative collector plate 16 that extends across the lower end of the core 15. Insulators 17, 19 separate the collector plates 14, 16 from each other and retain the parts in assembled relationship to form the housing 12.

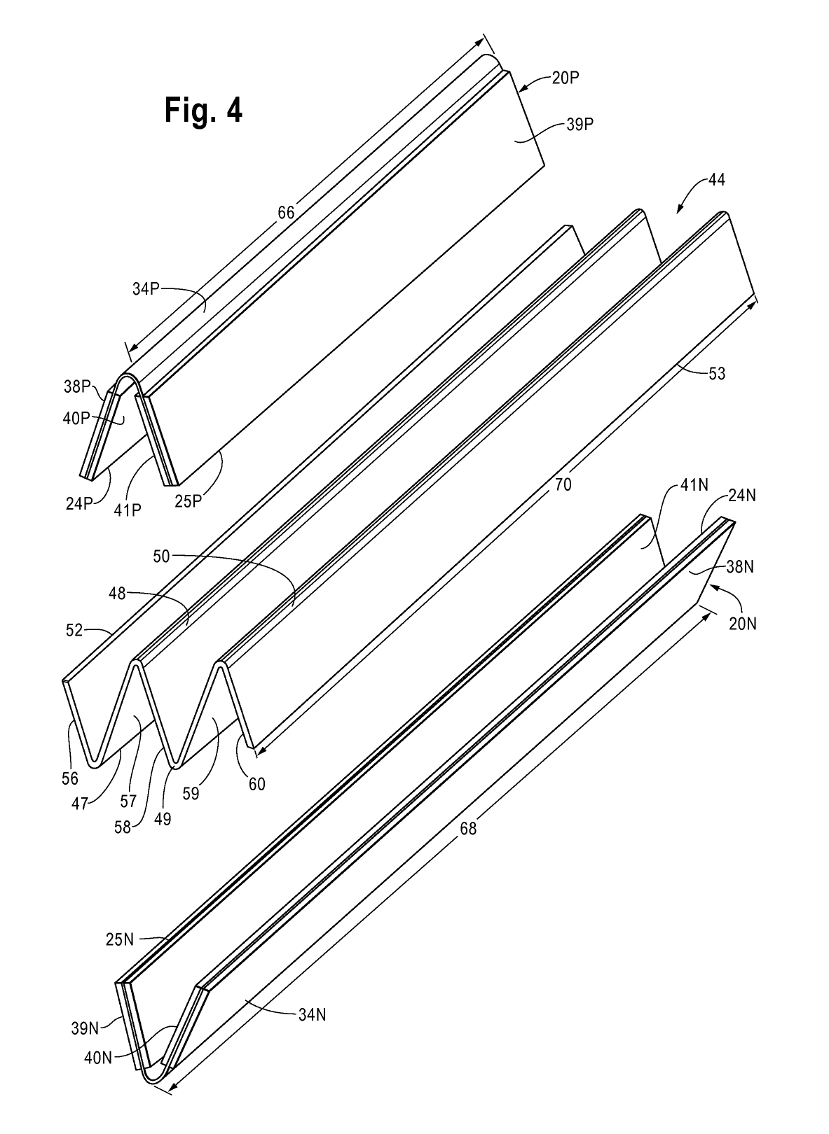

Referring to FIG. 3, each electrode 20 for use in the battery 10 is formed around an elongate strip of conductive material such as a metal foil 22. The conductive strip 22 has side edges 24, 25 and opposing planar surfaces 27, 28. The thickness of the strip 22 is minimized, limited only by the need for sufficient tensile strength so as not to tear or crumble as the electrode 20 is formed and assembled into a battery 10. Positioned on the upper and lower surfaces 27, 28 of the foil 22 is a coating of electrode material arranged in regions 38,39, 40, 41 as described below. The electrode material may be in the form of an oxide deposit. The electrode material 38-41 is of a porous substance which provides a very high surface area that will be exposed to an electrolyte within the core 15 of the battery 10. The exact consistency of the material in regions 38-41 is dependent therefore on the electrochemical process that is employed for the battery 10, but regardless of the electrochemical process employed, suitable electrode materials are well known in the art. For a negative electrode 20N, the electrode material in regions 38-41 is suitable to form a negative electrode, and for a positive electrode 20P, the material in regions 34-41 is suitable to form a positive electrode.

Referring to FIG. 3, electrodes are generally manufactured with electrode material extending across both surfaces 27, 28 of a foil 22. To form regions 38-41 that extend only along the edges 24, 25, the electrode strip is passed between a pair of opposing tools 32, 33 which may be blades or abrasive surfaces that remove the electrode material 38-41 from a strip that extends along the centerline of both surfaces 27, 28 thereof, leaving an exposed center strip 34, 35 on both sides of the foil 22. The electrode material on the surfaces 27, 28 is thereby oriented in parallel regions 38, 39, 40, 41 with regions 38, 39 extending along opposite edges 24, 25 of surface 27 and the remaining regions 40, 41 extending along opposite sides 24, 25 of surface 28. A positive electrode 20P having positive electrode material coated on the foil 22 can therefore be folded longitudinally along the strips 34, 35 of exposed foil 22 without damaging the foil 22 or damaging the coating of electrode material on the surfaces thereof. Similarly, a negative electrode 20N can also be folded along the exposed strips 34, 35 of the foil 22 without damaging the foil 22 or the coating of the negative electrode material.

Referring to FIGS. 2 and 4, to separate the positive and negative electrodes from each other, an elongate strip of insulating material 44 is provided. Like the electrodes 20P, 20N, the insulating strip 44 is preferably only a couple thousandths of an inch thick so as to consume a minimum volume within the battery 10. The thickness of the insulating strip 44 must be sufficient to provide the tensile strength needed to retain the strip intact during the manufacture of the battery 10 and to insulate between the positive and negative electrodes 20P, 20N and thereby prevent battery failure by virtue of a short. Such insulating material is well known in the art and is described in further detail in the material incorporated herein by reference.

The strip of insulating material 44 is folded along parallel longitudinal fold lines 47, 48, 49, 50, with each of the fold lines extending parallel to the outer edges 52, 53 so as form parallel panels 56, 57, 58, 59, 60, with each of the panels joined by a fold to one or more adjacent panels. Each of the panels 56, 57, 58, 59, 60 is approximately equal in width, where the width is the distance between an edge 52, 53 and a fold line 56-60 or between adjacent fold lines 56-60. The insulating material strip 44 also has two distal ends, one of which 45 is depicted with each of the distal ends 45 being perpendicular to the edges 52, 53 and the fold lines 56-60.

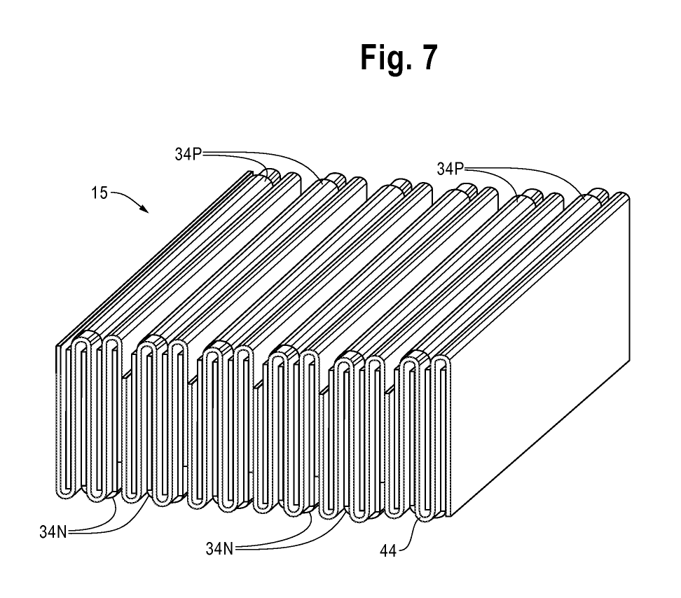

Referring to FIGS. 4, 5, and 6, the positive electrode 20P and the negative electrode 20N are positioned around the folds 47-50 of the insulating strip 44. The fold through exposed foil 34P, 35P of the positive electrode 20P is wrapped around the outer surfaces of one fold 48 of the insulating strip 44 such that the positive electrode regions 38P, 40P along side edge 24P fit between panels 56 and 57 of the strip 44 and the regions 39P, 41P along side edge 25P of electrode 20P fit between panels 58 and 59 of the insulating strip 44. Similarly, the negative electrode 20N is assembled to the insulating strip 44 with the negative electrode regions 39N, 41N positioned between panels 57 and 58 of the insulating strip 44 and the negative electrode panels 38N, 40N positioned between panels 59 and 60 of the insulating strip 44, and the fold through 34N, 35N extending around fold 49 of the insulating strip 44. As shown in FIG. 6, when the insulating strip 44, with the electrodes 20P, 20N assembled around the folds 48, 49 thereof and the various panels 56-60 is compressed together, the parts form an elongate bundle 62. The foil strip 34P of the positive electrode 20P will extend along one edge of the bundle 62 and the exposed foil strip 34N of the negative electrode 20N will extend along the opposing edge of the bundle 62. As can be seen, the outer edge 24P along one side of the positive electrode 20P will be enclosed by the fold 47 joining panels 56, 57 of the insulator 44 and the other edge 25P of the positive electrode 20P will be enclosed by fold 49 joining panels 58, 59. In similar fashion, side 24N of the negative electrode 20N is enclosed by fold 50 joining panels 59, 60 and the side 25N of the negative electrode 20N is enclosed by fold 48 joining panels 57 and 58. The only exposed portion of the positive electrode 20P is the elongate foil strip 34P and the only exposed portion of the negative electrode 20N is the elongate foil strip 34N.

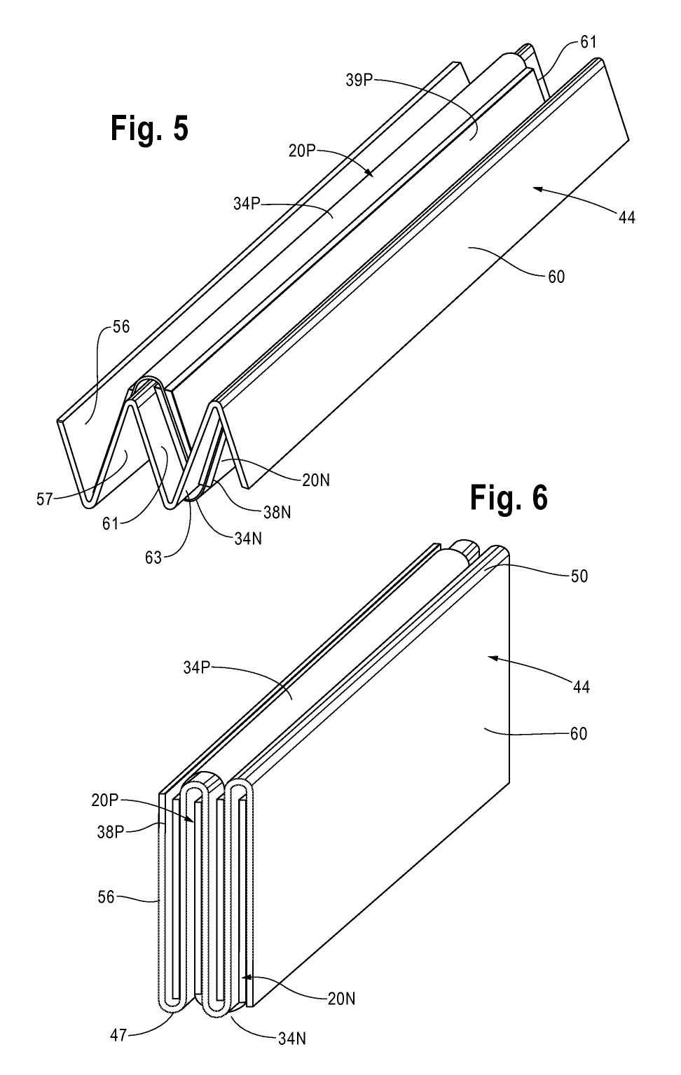

As shown in FIG. 5, the positive electrode 20F and the negative electrode 20N have overall lengths 66, 68 respectively that are equal to each other but are a little shorter than the overall length 70 of the associated insulating strip 44. When the positive and negative electrodes 20F, 20N are longitudinally centered with respect to the insulating strip 44 and are assembled to the insulating strip 44, a portion 61 at each end of the insulating strip 44 will extend outward of both distal ends of the positive electrode 20P and a portion 63 at each end of the insulating strip 44 will extend outward of the distal ends of the negative electrode 20N. The portions 61, 63 of the insulating material 44 that extends longitudinally outward of the positive and negative electrodes 20P, 20N insulate the outer ends of each bundle 62 against a short occurring around either of the distal ends 45 of the insulator 44. The portions 61, 63 also insulate the electrodes 20P, 20N against a short to an electrically conductive portion of the housing 12.

Referring to FIGS. 6 and 7, a core 15 of battery 10 is formed by a plurality of elongate bundles 62 arranged is side-by-side orientation with the positive electrode strips 34P oriented adjacent one another and the negative electrode strips 34N oriented adjacent one another opposite the positive electrode strips 34P.

As shown in FIG. 1, to complete the assembly of the battery, the core 15 is positioned between the positive collector plate 14 and negative collector plate 16 with the aligned exposed foil surfaces 34P of the positive electrodes positioned against the positive collector plate 14 and the aligned exposed foil surfaces 34N of the negative electrodes 20N positioned against the negative collector plate 16. The insulating strip 44 is of course saturated with a suitable electrolyte consistent with the electrochemical technology of the battery 10.

A battery 10 having a core 15 as described above can be relatively inexpensively manufactured and will provide a reliable layer of insulation between every portion of both the positive and the negative electrodes. Furthermore, electric energy formed on the surfaces of the electrodes 20P, 20N need only travel the distance between the outer edge 24, 25 of the associated electrode 20P, 20N to the exposed strip of foil 34P, 34N thereby minimizing the internal resistance of the battery and minimizing the heat generated therein.

Referring to FIG. 9, as an alternative to forming a core 15 consisting of a plurality of side-by-side elongate bundles of equal length, a core 72 can be made from a single bundle 62 in the form of an elongate serpentine strip 71 having folds 74, 75, 76. . . . In this embodiment, the strip 71 is folded back and forth upon itself to create the core 72 with the entire length of the exposed foil 34P of the positive electrode aligned to contact the positive collector plate 14 and the entire length of the exposed foil 34N of the negative electrode 20N aligned to contact the negative connector plate 16 on the opposite side of the core 72.

Referring to FIGS. 5 and 9, the positive and negative electrode strips 20P, 20N are also folded as the insulator 44 is folded, but a tear transverse to their length will not inhibit the operation of the battery whereas a tear in the insulator 44 would likely result in a short. The insulators 44 of a serpentine bundle 72 must therefore have sufficient elasticity so as not to tear at the folds 74-76.

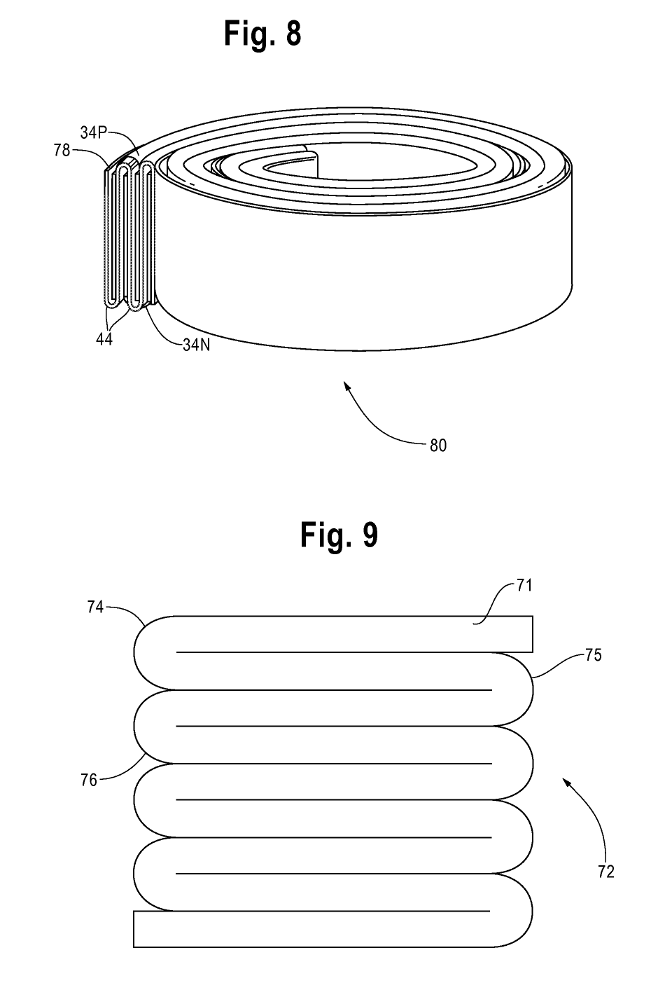

Referring to FIG. 8, in yet another embodiment, a single elongate bundle strip of indefinite or extended length 78 may also be formed into a coiled core 80 to form a generally cylindrical battery. In this embodiment, the entire length of the exposed foil 34P of the positive electrode 20P will contact a planar surface of a circular collector plate, not shown, to form the positive contact and the entire length of the exposed surface 34N of the negative electrode 20N will contact a planar surface of a circular negative connector plate, also not shown.

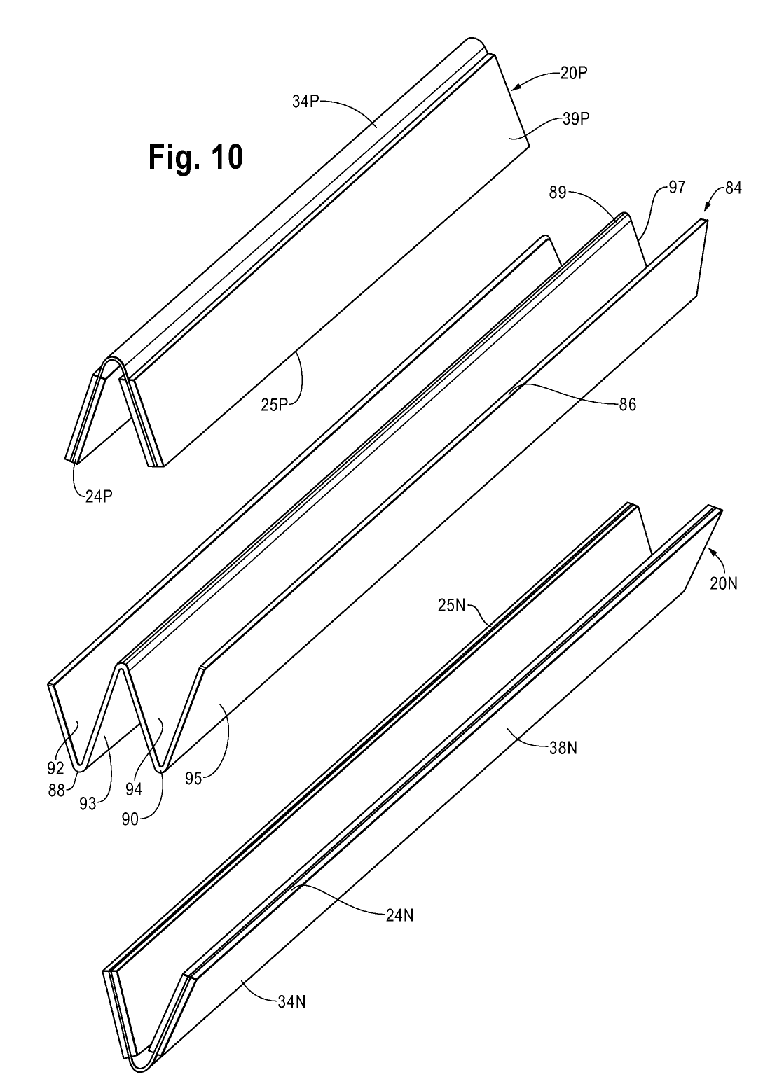

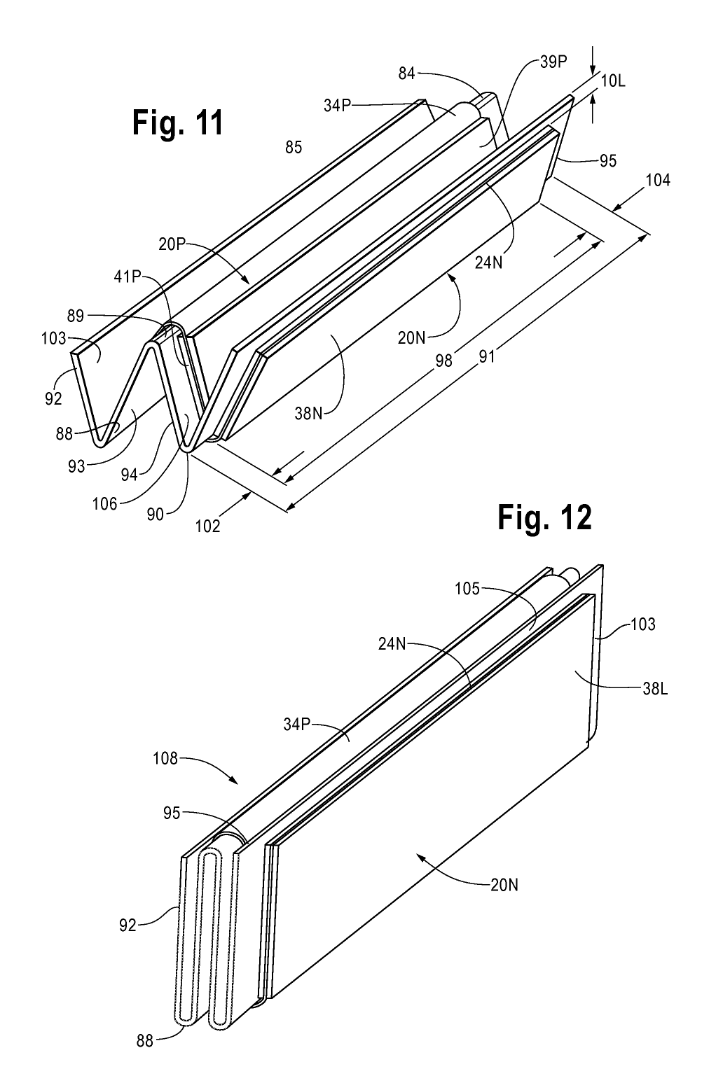

Referring to FIGS. 10, 11, and 12, in an alternate embodiment, the positive and negative electrodes 20P, 20N as described and depicted in FIGS. 4-6 may be fitted around an elongate insulator strip 84 having parallel sides 85, 86 and, extending longitudinally parallel to the sides 85, 86, three parallel folds 88, 89, 90 that are generally spaced from each other and from the adjacent sides 85, 86 thereby forming four parallel panels 92, 93, 94, 95. The insulator 84 also has distal ends 96, 97 that are perpendicular to the sides 85, 86 and the folds 88, 89, 90. The overall length 91 of the insulator strip 84 is a littler longer than the overall lengths 98, 99 of the positive and negative electrodes 20P, 20N. In this embodiment, outer edge 25P of the positive electrode 20P is fitted between panels 92 and 93 of the insulator 84 and is enclosed by fold 88 and outer end 25P is fitted between panels 94 and 95 and enclosed by fold 90. Outer end 25N of the negative electrode 20N is fitted between panels 93 and 94 of the insulator 84 and enclosed by fold 89, however, the outer surfaces 38N of the negative electrode 20N is exposed because the side 24N extends along the outer surface of panel 95 of insulator 84.

The positive electrode 20N is positioned around the fold 90 of the insulator 84 with a small portion 101, 103 of the insulator 84 extending a short distance 102, 104 from both ends of the positive electrode 20N. The portions 101, 103 at each end of the insulator 84 are substantially equal to each other and sufficient to prevent a short from occurring around the distal ends 96, 97 of the insulator 84. In similar fashion, the positive electrode 20P is longitudinally centered with respect to the insulators 84 such that a portion, unnumbered, of the insulator 84 extends longitudinally beyond both ends of the positive electrode 20P to ensure that a short will not occur around the ends 96, 97 of the insulator 84. Also, the overall width of the electrode region 38N of positive electrode 20N is a little less than the overall width of the panel 95 of the insulator 84 such that a portion 105 of the insulator 84 extends a short distance 106 beyond the end 24N of the negative electrode 20N. The portion 106 is sufficient to insure that a short will not occur around the side 86 of panel 95.

The parts are thereafter compressed together to form an elongate bundle 108 having a length 91. The bundles 108 are positioned in parallel alignment similar to the bundles 62 depicted in FIG. 7. In this embodiment, the outer panel 92 of insulator 84 for one bundle 108 will abut against the exposed surface of negative electrode 38N, thereby insulating the otherwise exposed surface 38N. It should be apparent that the outer panel 92 must have dimensions identical to panel 95 such that when positioned against the surface of negative electrode 38N, a portion of the insulating material of panel 92 will extend beyond the outer edges (portions 101, 103 and 105) of electrode panel 38N. Also, the surface of electrode 38N of the outermost bundle 108 will remain exposed and will contact an inner surface of the housing 12. The inner surface of the housing 12 that contacts the surface of electrode 38N therefore must be insulated from the positive collector plate 14 to prevent a short form occurring.

In similar fashion, the bundle 108 may be made to a substantially longer length and coiled similar to the coiled bundle depicted in FIG. 9. When coiled, a portion of the outer surface of panel 92 will again abut against the exposed negative electrode panel 38N to thereby insulate the outer surface of the panel 38N against a short occurring. As stated above, the panel 92 must again have a width substantially equal to the width of panel 95 such that the outer edge 24N of negative electrode 20N is spaced from the outer edge of the panel 92 sufficient to adequately insulate the negative electrode panel 38N.

It should also be appreciated that in the embodiments depicted in FIGS. 10 through 12, the positive and negative electrodes may be interchanged such that one panel of the positive electrode 20P lies exposed along the outer surface of an insulating panel 95 instead of a panel of the negative electrode 20N as depicted. Whether a battery is assembled with parallel bundles 108 of a fixed length 91 to form a rectangular battery core or a single bundle 108 is configured as an elongate strip coiled to form a cylindrical core as depicted in FIG. 9, the core as positioned between positive and negative collector plates 14, 16 and assembled into a suitable housing, not shown, to form a battery.

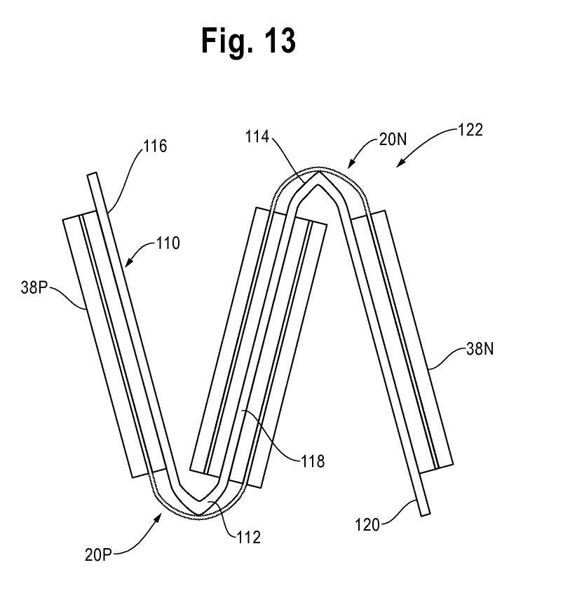

Referring to FIG. 13, in the simplest form, the insulator 110 for a battery in accordance with the present invention need only have two longitudinal folds 112, 114 along the length thereof forming only three parallel panels 116, 118, 120. In this embodiment, the positive electrode 20P will be fitted around one fold 112 and the negative electrode 20N will extend around the other fold 114 forming a bundle 122 with a panel 38P of positive electrode 20P along one outer surface and a panel 38N of the negative electrode 20N along the opposite outer surface. The bundle 122 is suitable for forming a very thin battery in which the bundle 122 is in an enclosure having insulating panels against each of the outer electrode panels 38P, 38N.

The battery in accordance with the present invention can be easily manufactured because the assembly does not required the high level of precision to manufacture. The panels of insulating material 44, 84 will be adequate to prevent an internal short.

While the present invention has been described with respect to several embodiments, it will be appreciated that many modifications and variations may be made without departing from the spirit and scope of the invention. It is therefore the intent of the appended claims to cover all such modifications and variations which fall within the spirit and scope of the invention.

What is claimed:

1. A battery comprising,
an elongate bundle,
said bundle including an insulator having a plurality of at least two longitudinal folds therein forming a plurality of at least three parallel insulator panels,
said insulator having no more than four longitudinal folds therein wherein said insulator has no more than five parallel panels,
said bundle further including a positive electrode having only one longitudinal fold forming two parallel panels joined at said fold,
said bundle further including a negative electrode having only one longitudinal fold forming two parallel panels joined at said fold,
said positive electrodes folded around a first fold of said insulator with said fold of said positive electrode extending outward of said folded insulator in a first direction,
said negative electrode folded around a second fold of said insulator with said fold of said negative electrode extending outward of said folded insulator in a second direction different from said first direction,
a positive collector contacting said fold of said positive electrode, and
a negative collector contacting said fold of said negative electrode.

2. The battery of claim 1 wherein
said insulator has a length longer than lengths of said positive electrode and said negative electrode,
said positive electrode is longitudinally centered with respect to said insulator leaving a portion of said insulator extending from each end of said positive electrode, and
said negative electrode is longitudinally centered with respect to said insulator leaving a portion of said insulator extending from each end of said negative electrode.

3. The battery of claim 1 wherein
one of said positive and said negative electrodes comprises
an electrically conductive panel having parallel edges and a longitudinal fold extending parallel to said edges forming said two parallel panels joined at said fold,
a region of electrode material on opposing surfaces of both said panels, and
a strip of said electrically conductive material along both surfaces of said fold being free of said electrode material wherein said electrode material will not interfere with said fold and an outer surface of said electrically conductive panel at said fold contacts one of said positive and negative collectors.

4. The battery of claim 1 wherein
said insulator has at least three longitudinal folds forming at least four parallel insulator panels.

5. The battery of claim 4 wherein
said insulator has a length longer than lengths of said positive electrode and said negative electrode,
said positive electrode is longitudinally centered with respect to said insulator leaving a portion of said insulator extending from each end of said positive electrode, and
said negative electrode is longitudinally centered with respect to said insulator leaving a portion of said insulator extending from each end of said negative electrode.

6. The battery of claim 4 and further comprising
a second elongate bundle identical to said elongate bundle,
said elongate bundle and said second elongate bundle arranged parallel to each other with said folds of said positive electrode of both said bundles contacting said positive collector and said folds of said negative electrode of both said bundles contacting said negative collector.

7. The battery of claim 4 wherein said bundle is wrapped into a coil to form a cylindrical core having a planar first end and a planar second end, said fold of said positive electrode at said first end and said fold of said negative electrode at said second end.

8. The battery of claim 4 wherein
one of said positive and said negative electrodes comprises
an electrically conductive panel having parallel edges and a longitudinal fold extending parallel to said edges forming said two parallel panels joined at said fold,
a region of electrode material on opposing surfaces of both said panels, and
a strip of said electrically conductive material along both surfaces of said fold being free of said electrode material wherein said electrode material will not interfere with said fold and an outer surface of said electrically conductive panel at said fold contacts one of said positive and negative collectors.

9. The battery of claim 4 wherein said elongate bundle is folded back and forth in a serpentine configuration to form a core of said battery.

10. The battery of claim 4 wherein
a panel of one of said positive or said negative electrodes extends along an outer surface of said bundle, and
a width of said panel of said one of said electrodes is less than a width of an adjacent one of said insulator panels wherein an edge of said panel of said one of said electrode is spaced from an edge of said adjacent one of said insulator panel.

11. The battery of claim 4 wherein
one of said positive and said negative electrodes comprises
an electrically conductive panel having parallel edges and a longitudinal fold extending parallel to said edges forming said two parallel panels joined at said fold,
a region of electrode material on opposing surfaces of both of said panels,
a strip of said electrically conductive panel along said fold being free of said electrode material wherein said electrode material will not interfere with said fold, and an outer surface of said electrically conductive panel at said fold contacts one of said positive and negative collectors,
said insulator has a length longer than lengths of said positive electrode and said negative electrode,
said positive electrode is longitudinally centered with respect to said insulator leaving a portion of said insulator extending from each end of said positive electrode,
said negative electrode is longitudinally centered with respect to said insulator leaving a portion of said insulator extending from each end of said negative electrode, and
said positive electrode is folded around a first fold of said insulator and said negative electrode is folded around a second fold of said insulator.

12. The battery of claim 11 wherein
a panel of one of said positive or said negative electrodes extends along an outer surface of said bundle, and
a width of said panel of said one of said electrodes is less than a width of an adjacent one of said insulator panels wherein an edge of said panel of said one of said electrode is spaced from an edge of said adjacent one of said insulator panels.

13. A battery comprising
an insulator strip having a length and first and second parallel longitudinal edges,
said insulator strip having four parallel longitudinal folds therein, said folds parallel to said edges wherein said insulator strip has five panels with each panel separated from an adjacent panel by one of said folds,
a positive electrically conductive panel having first and second parallel longitudinal edges,
said positive electrically conductive panel having only one longitudinal fold therein, said fold midway between said longitudinal edges wherein said positive electrode panel is divided into two panels joined at said fold,
a positive electrode material on opposing surfaces of said two positive electrically conductive panels to form a positive electrode,
said positive electrically conductive panel being free of said positive electrode material in a strip along said fold wherein said positive electrode material will not interfere with said fold and an outer surface of said positive electrically conductive material is exposed at said fold,
said positive electrode folded around one of said folds of said insulator strip,
a negative electrically conductive panel having first and second parallel longitudinal edges,
said negative electrically conductive panel having only one longitudinal fold therein, said fold midway between said longitudinal edges wherein said negative electrically conductive panel is divided into two negative electrically conductive panels joined at said fold,
a negative electrode material on opposing surfaces of said two negative electrically conductive panels to form a negative electrode, said negative electrode panel being free of said negative electrode material in a strip along said fold wherein said negative electrode material will not interfere with said fold and an outer surface of said negative electrically conductive panel is exposed at said fold, and
said negative electrode folded around a second of said folds of said insulator strip.

14. The battery of claim 13 wherein
said insulator strip has a length longer than lengths of said positive electrode and said negative electrode,
said positive electrode is longitudinally centered with respect to said insulator strip leaving a portion of said insulator strip extending from each end of said positive electrode, and
said negative electrode is longitudinally centered with respect to said insulator strip leaving a portion of said insulator strip extending from each end of said negative electrode.

15. The battery of claim 13 wherein
said insulator strip and said positive and negative electrodes form a first bundle, and said battery further comprises
a second bundle including an insulator strip, a positive electrode and a negative electrode all identical to said first bundle,
said second bundle parallel to said first bundle,
said fold of said positive electrode of said first bundle adjacent said fold of said positive electrode of said second bundle,
said fold of said negative electrode of said first bundle adjacent said fold of said negative electrode,
a positive collector contacting said folds of said positive electrodes of said first and second bundles, and
a negative collector contacting said folds of said negative electrodes of said first and second bundles.

16. The battery of claim 13 wherein
said insulator strip and said positive and negative electrodes form a elongate bundle, and
said bundle is wrapped into a coil to form a cylindrical core having a planar first end and a planar second end,
said fold of said positive electrode at said first end and said fold of said negative electrode at said second end.

17. The battery of claim 13 wherein
said insulating strip and said positive and negative electrodes form an elongate bundle, and
said elongate bundle is folded back and forth in a serpentine configuration to form a core of said battery.

18. A battery comprising,
an elongate bundle,
said bundle including an insulator having four parallel longitudinal folds therein forming a few parallel insulator panels,
said bundle further including a positive electrode and a negative electrode,
said positive electrode including a positive electrically conductive panel having a first and a second surface and parallel spaced apart longitudinal edges,
said positive electrically conductive panel having a longitudinal fold parallel to one of said edges wherein said longitudinal fold forms two parallel panels joined at said fold,
regions on both said first and second surfaces of said positive electrically conductive panel having positive electrode material thereon, and
a strip of said positive electrically conductive panel being free of said electrode material, said strip extending along said fold on said first surface and said second surface wherein said electrode material will not interfere with said fold, and an outer surface of said positive electrically conductive panel is exposed to said fold,
said negative electrode including a negative electrically conductive panel having a first and a second surface and parallel spaced apart longitudinal edges,
said negative electrically conductive panel having a longitudinal fold parallel to one of said edges wherein said longitudinal fold forms two parallel panels joined at said fold,
regions on both said first and second surfaces of said negative electrically conductive panel having negative electrode material thereon, and
a strip of said negative electrically conductive panel being free of said electrode material, said strip extending along said fold on said first surface and said second surface wherein said electrode material will not interfere with said fold, and an outer surface of said negative electrically conductive panel is exposed at said fold,
said positive electrode folded around a first of said folds of said insulator with said fold of said positive electrode extending outward of said folded insulator in a first direction,
said negative electrode folded around a second of said folds of said insulator with said fold of said negative electrode extending outward of said folded insulator in a second direction different from said first direction,
a positive collector contacting said fold of said positive electrode,
a negative collector contacting said fold of said negative electrode,
said insulator having a length longer than lengths of said positive electrode and said negative electrode,
said positive electrode longitudinally centered with respect to said insulator leaving a portion of said insulator extending from each end of said positive electrode, and
said negative electrode longitudinally centered with respect to said insulator leaving a portion of said insulator extending from each end of said negative electrode.

19. The battery of claim 18 and further comprising
a second elongate bundle identical to said elongate bundle,
said elongate bundle and said second elongate bundle arranged parallel to each other with said folds of said positive electrode of both said bundles contacting said positive collector and said folds of said negative electrode of both said bundles contacting said negative collector.

20. A battery comprising
an insulator strip having a length and first and second parallel longitudinal edges,
said insulator strip having three parallel longitudinal folds therein, said folds parallel to said edges wherein said insulator strip has four panels with each panel separated from an adjacent panel by one of said folds,
a positive electrically conductive panel having first and second parallel longitudinal edges,
said positive electrically conductive panel having only one longitudinal fold therein, said fold midway between said longitudinal edges wherein said positive electrode foil is divided into two panels joined at said fold,
a region of positive electrode material on opposing surfaces of said two positive electrically conductive panels to form a positive electrode,
said positive electrically conductive panels being free of said positive electrode material in a strip along said fold wherein said positive electrode material will not interfere with said fold and an outer surface of said positive electrically conductive material is exposed at said fold,
a negative electrically conductive panel having first and second parallel longitudinal edges,
said negative electrically conductive panel having only one longitudinal fold therein, said fold midway between said longitudinal edges wherein said negative electrically conductive panel is divided into two negative electrically conductive panels joined at said fold,
a negative electrode material on opposing surfaces of said two panels of said negative electrically conductive panel to form a negative electrode,
said negative electrically conductive material being free of said negative electrode material in a strip along said fold wherein said negative electrode material will not interfere with said fold and an outer surface of said negative electrically conductive panels is exposed at said fold, and
one of said positive and said negative electrodes folded around one of said folds of said insulator strip with said fold extending outward of said insulator strip in a first direction,
the other of said positive and negative electrode folded around at least one of said panels of said insulator material with said fold of said other of said electrode extending outward of said insulator in a second direction different from said first direction,
said insulating strip and said positive and negative electrodes forming an elongate bundle with a panel of said other of said positive and said negative electrodes extending along an outer surface of said bundle, and
a width of said panel of said other of said electrodes is less than a width of an adjacent one of said insulator panels wherein an edge of said panel of said one of said electrodes is spaced from an edge of said adjacent one of said insulator panels.
